(19) United States
(12) Patent Application Publication
(10) Pub. No.: US 2017/0057151 A1
(43) Pub. Date: Mar. 2, 2017

(54) REMOVABLE EXTRUDER ADAPTER FOR IMPROVED FEED

(71) Applicant: NOVA Chemicals (International) S.A., Fribourg (CH)

(72) Inventors: Eric Clavelle, Calgary (CA); Robert Hugh Clare, Cochrane (CA); William McGrory, Calgary (CA); Allister William Davey, Didsbury (CA)

(73) Assignee: NOVA Chemicals (International) S.A., Fribourg (CH)

(21) Appl. No.: 15/244,084

(22) Filed: Aug. 23, 2016

Related U.S. Application Data
(60) Provisional application No. 62/213,786, filed on Sep. 3, 2015.

(30) Foreign Application Priority Data
Aug. 26, 2015 (CA) 2901719

(51) Int. Cl. B29C 47/08

(52) U.S. Cl. CPC B29C 47/0842

(57) ABSTRACT

Methods for altering feed throat passageway size, shape and position in a pellet fed extruder by means of a removable adapter are disclosed. Adapters chosen for optimal extrusion performance may be removed with little effort in a shorter time and may be more cost effective than other methods for optimization of extrusion including replacing the screw or by replacing the feed throat through purchase of a different extruder.

Disclosed herein are pellet fed screw extruders. In some embodiments, the disclosure relates to the optimization of extruder feeding via the feed throat passageway by using an inserted adapter that alters size, position, and or shape of feed throat opening.

From start to finish, extrusion of plastics requires precision to allow efficient and consistent processing for a variety of different plastics applications. Different polymers may require different conditions to achieve a high level of quality. Problems arise when polymers cannot flow freely and consistently within an extruder, resulting in pressure fluctuations, production rate drop, uneven mixing and a poor quality product. While the main focus for troubleshooting extrusion problems focuses on screw design it is known that feed throat geometry also plays a role because if the polymer cannot reach the screw it cannot flow.

In an ideal polymer extruder the feed throat geometry is such that polymer transfer from the hopper into the barrel is seamless and consistent. In smaller screws issues can arise including bridging of pellets across the feed opening or kick back associated with high speed of screw rotation. When these problems occur filling levels of polymer within the barrel vary resulting in pressure fluctuations that ultimately effect heating and movement of polymer as it moves through the various sections of the plasticizing screw towards the die. This leads directly to ineffective extrusion and likely to changes to the production rate and or properties of the resulting extrudate.

Studies on feed throat geometry have shown that feed openings with rectangular shape are the most effective in transferring polymer from the hopper to the extruder barrel. The long side of the rectangle corresponds to the longitudinal axis of the screw which works to ensure the space between successive flights on the screw are optimally filled with each rotation of the screw. Other features that may be beneficial are mirroring the size and shape of the hopper outlet and feed opening, and shifting the longitudinal axis of the feed opening relative to the longitudinal axis of the screw towards the screw rotation direction so that incoming polymer is directed down into the barrel as opposed to being kicked back towards the hopper. For a discussion on feed throat size and position see “Impact of Feed Opening Width and Position on PVC Extrusion Process Effectiveness” by J. W. Sikora and B. Samujto in International Polymer Processing, Volume 28, No. 3, pages 291-299.

Altering flow through the feed throat is known in the prior art. In U.S. Pat. No. 6,328,919, a two-stage screw along with a hopper with a prescribed cone angle and a specific feed throat dimension are described that prevent pressure fluctuations during extrusion of low density polymers. U.S. Pat. No. 5,096,302 describes the use of a valve within the feed throat that prevents accumulation of polymer particulates directly above the screw. Neither of these solutions teach alteration of the feed throat geometry for an existing extruder.

U.S. Pat. No. 4,863,366 granted to B.F. Goodrich Company describes the use of a deflector unit, mounted within the feed throat, which guides incoming polymer to the upstream end of the extruder screw. The preferred and only embodiment described involves use of hot plastic melt and an extruder with a circular feed throat. It does not teach the alteration of feed throat shape and size or position of feed throat opening with respect to the longitudinal axis of the extruder screw using a removable adapter.

While optimizing feed throat shape and design is known, it is not always feasible, economically or logistically, to replace an extruder. Replacing the screw takes time and depending upon the form of the polymer is not guaranteed to fully correct problems associated with inconsistent feeding. What is needed is an alternative for altering the feed throat of an existing extruder that is cost efficient and can be done without the need for significant downtime.

We have found that a polymer extruder containing a removable feed throat adapter is a cost effective way to optimize, in an existing extruder, transfer of polymer from the hopper to the barrel. Different adapters can be exchanged quickly and tailor made to optimize transfer for different polymeric material by altering the shape, size, and or position relative to longitudinal axis of the rotating screw of the passageway between the hopper and the extruder barrel. The design is directed toward ensuring polymeric material is directed down into the barrel instead of blocking the feed throat or being kicked back by the upward force of the rotating screw.

Provided is a polymer extruder comprising an extruder barrel, a feed hopper, at least one extruder screw, and at least one removable adapter that cooperates with the feed hopper and the feed throat in a manner that alters one or both of the volume of the passageway between the hopper and the barrel and the surface area of the extruder screw directly exposed to the passageway within the feed throat.

Provided is a process for extrusion of polymeric material comprised of feeding said polymeric material to an extruder comprising an extruder barrel, a feed hopper, at least one extruder screw, and at least one removable adapter that cooperates with the feed hopper and the feed throat in a manner that alters one or both of the volume of the passageway within the feed throat between the hopper and the barrel and the surface area of the extruder screw directly exposed to the passageway within the feed throat.

Provided is a removable feed throat adapter for use in polymer extruders for altering shape, size, and position relative to longitudinal axis of extruder screw the passageway within the feed throat comprising an upper portion for attachment or cooperation with feed hopper and feed throat and a central portion containing a passageway that differs from and alters, when in position, the passageway within the feed throat of an existing extruder.

### BRIEF DESCRIPTION OF THE DRAWINGS

FIG. 1A—Cross-section of longitudinal axis of polymer extruder with adapter.

FIG. 1B—Cross-section of longitudinal axis of polymer extruder, close up of feed throat without adapter.

FIG. 2A—Cross-section of rotating axis of extruder screw, feed throat, and extruder barrel with adapter.

FIG. 2B—Cross-section of rotating axis of extruder screw, feed throat, and extruder barrel without adapter.

FIG. 2C—Cross-section of rotating axis of extruder screw, feed throat, and extruder barrel with adapter with different means of attachment.

FIG. 3A—View down through feed throat of exposed surface area of extruder screw without adapter.

FIG. 3B—View down through feed throat of exposed surface area of extruder screw with adapter that reduces width of exposed surface area of extruder screw.

FIG. 3C—View down through feed throat of exposed surface area of extruder screw with adapter that reduces length on both sides by varying degrees of exposed surface area of extruder screw.

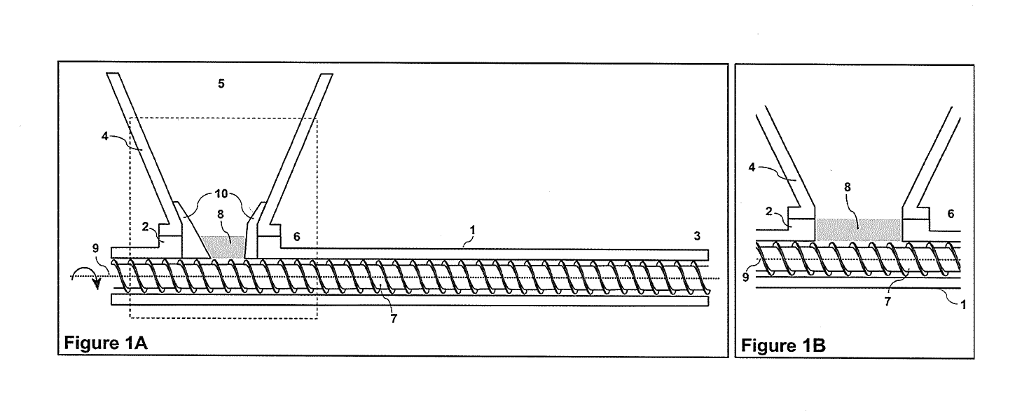

The polymer extruder of the present invention, longitudinal cross section illustrated in FIG. 1A, comprises an extruder barrel 1, said extruder barrel 1 having a feed throat 2 and a barrel discharge end 3. Attached to said extruder barrel 1 is the feed hopper 4 which accepts polymer via a feed opening 5 and discharges polymer through the discharge end 6 and into the extruder barrel 1 by way of the feed throat 2. Once inside the barrel the polymer is transported towards the barrel discharge end 3 through rotation of the extruder screw 7 by a motor (not shown).

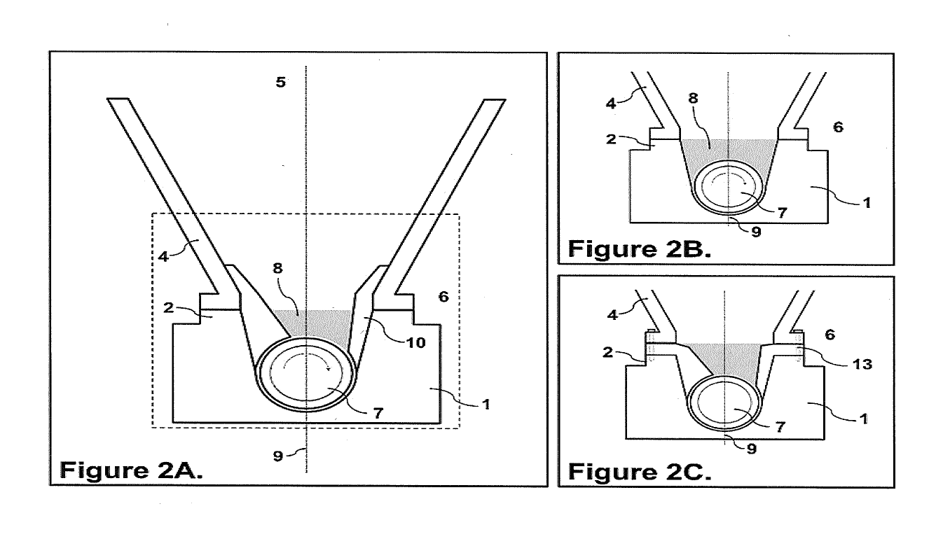

The space where polymer passes between the feed hopper 4 and feed throat 2 comprises a passageway 8, indicated by shaded regions in FIGS. 1 and 2, which is the target of the present invention. By altering the shape of passageway 8 and position of passageway 8 relative to the longitudinal axis 9 of the extruder screw 7 the movement of polymer from the feed hopper 4 to the extruder barrel 1 can be improved. Alteration of passageway 8 is achieved by inserting an adapter 10, designed to promote movement of polymer into the extruder barrel 1, as opposed to polymer blocking the passageway or getting kicked back into the feed hopper 4 by the force of the rotating extruder screw 7. FIG. 1B shows a section of the extruder from FIG. 1A (within the box indicated with dotted lines) but without the replaceable adapter 10, highlighting the change in the size and shape of passageway 8. The adapter 10 shown in FIG. 1A is a non-limiting example of how the passageway can be altered. FIG. 2A is an illustration of a cross section of the extruder barrel 1 showing the same components, except the barrel discharge end 3, from FIG. 1A. FIG. 2B shows a section of the barrel from FIG. 2A (within the box indicated with dotted lines) but without the replaceable adapter 10, again highlighting the change in the size and shape of the passageway 8.

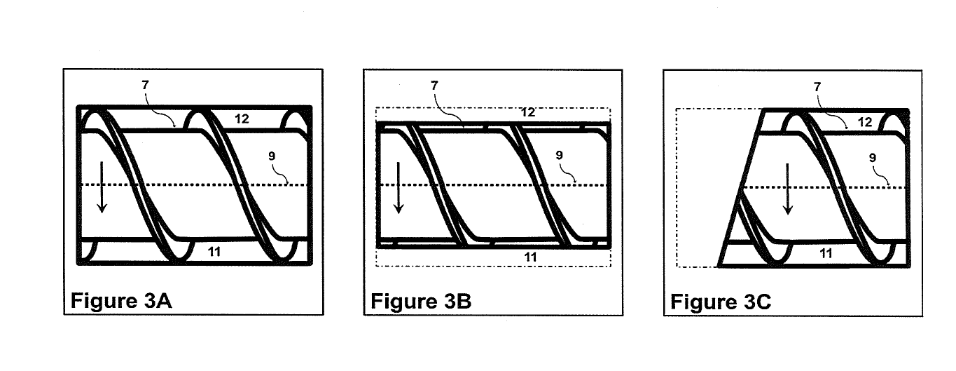

FIGS. 3A-3C are non-limiting illustrations of the view from the feed hopper 4 down through the passageway 8 between the discharge end 6 and feed throat 2, revealing the exposed surface area of extruder screw 7. FIG. 3A illustrates the size of the exposed surface area without the replaceable adapter 10. In contrast, the addition of the replaceable adapter 10 in FIG. 3B shows a change in the width of the exposed surface area. Also, FIG. 3C shows how the replaceable adapter 10 can change not only the size, but also the general shape by reducing the length on different sides of the screw by different amounts. The dashed lines in FIGS. 3B and 3C indicate the boundaries of the exposed surface when there is no adapter present, highlighting further the change in the size and shape of the exposed surface area of the extruder screw 7.

The rotation of extruder screw 7, indicated by the downward facing arrow, highlights that the side of the extruder screw 7 at the bottom of each of FIGS. 3A-3C is moving downwards toward the bottom of the extruder barrel 1, and the side of the screw at the top of each figure is moving upwards toward the feed hopper 4. The side of extruder screw 7 that is moving downward is the incoming side 11 and the side moving upwards is the counter side 12. As seen in FIG. 3C, the replaceable adapter 10 may change the shape of the exposed surface area by altering the length on the counter side 12 by a greater amount than that of the incoming side 11.

### Extruder Screw and Barrel

As used herein, “existing extruder” refers to an extruder that is lacking an adapter 10.

Disclosed herein are a device and method directed towards improving the flow of polymer from the hopper into the barrel by alteration of the passageway between those components. The effectiveness of the adapter is not dependent upon the nature of the extruder screw or the extruder barrel. The exception being that problems associated with transfer of polymer into the barrel are not generally seen in larger extruders and as a result the extruders useful for the designs and methods herein contain a screw with a diameter D of less than 4 cm.

In an embodiment of the invention, the diameter of extruder screw 7 is between 1 and 4 cm. In a further embodiment of the invention the diameter of extruder screw 7 is between 1 and 3.5 cm. In a further embodiment of the invention the diameter of extruder screw 7 is between 1 and 3.0 cm. In a further embodiment of the invention the diameter of extruder screw 7 is between 1 and 2.5 cm.

Screw design is another consideration when trying to optimize efficiency of extrusion. Screws are divided into a feed section, a transition section and a metering section. Various designs are well known in the art where the geometry parameters of the sections are adjusted to promote homogenous movement, melting, and mixing of polymer as it moves toward the die. The parameters include the channel depth, flight width, and flight clearance for example. Each section may be adjusted independently of the other sections. The designs and methods disclosed herein are not dependent upon screw design and may be used for any type of screw subject to the limitation of size as discussed above.

Another aspect that is taken into account when trying to improve extrusion is the properties of the extruder barrel. Using grooved as opposed to smooth barrels can improve the feeding of polymer. Altering the number, size and shape of the grooves may have different effects on different types of polymer. The present invention is not dependent upon the type of extruder barrel used as any type of barrel may be used in conjunction with the present invention.

The shape and size of the passageway of an existing extruder may impact the efficiency of extrusion. Extruders generally are designed with either a rectangular or circular passageway. It is known in the art that rectangular passageways are less susceptible to feeding problems than circular passageways. For the present invention there is no limitation on the shape of the passageway for an existing extruder. In an embodiment of the invention the entrance and end of the passageway of the existing extruder comprises a rectangular cross-section shape (as viewed from the hopper as shown in FIGS. 3A and 3B). As used herein the dimensions of the rectangle are defined by a width W or W′ for the entrance and end respectively, and a length L or L′, for then entrance and exit respectively. W and W′ are the sides of the respective rectangles that are perpendicular to the longitudinal axis 9 of the barrel and L and L′ are the sides of the respective rectangles that are parallel to the longitudinal axis 9 of the barrel.

The cross-sectional size and shape may change or may be constant throughout the depth of the passageway, where depth of the passageway refers to the distance between the entrance and exit of the passageway.

In an embodiment of the invention, the existing extruder comprises an entrance and end to the passageway having similar dimensions where W is similar to W′ and L is similar to L′, and W, W′, L, and L′ remain constant throughout the depth of the passageway.

In another embodiment of the invention, the existing extruder comprises an entrance end to the passageway having a rectangular cross-sectional shape with dimensions of W and L, and W′ and L′, respectively, where the cross-sectional size decreases along the depth of the passageway such that W and L decrease proportionally so that W is greater than W′ and L is greater than L′.

While it is known that rectangular shaped feed throats and their corresponding passageways are less susceptible to feed problems than their circular counterparts there are existing extruders with circular passageways. As used herein the dimensions of the circle are defined by a radius R or R′ for the entrance and end respectively.

In an embodiment of the invention, the existing extruder comprises an entrance and end to the passageway having a circular cross-sectional shape with a radius R and R′, respectively, where R remains constant throughout the depth of the passageway, and R is similar to R′.

In another embodiment of the invention, the existing extruder comprises an entrance to the passageway having a circular cross-sectional shape with a radius R, the cross-sectional size decreases along the depth of the passageway, and the end of the passageway, which corresponds to the exposed surface area of the rotating screw, comprises a circular shape with a decreased radius such that R is greater than R′.

### Replaceable Adapter

As used herein the “adapter passageway” refers to the passageway 8 between the hopper 4 and the barrel 3 when adapter 10 is in its place. See FIGS. 1A, 2A, and 2C.

While different extruder screw and barrel types may be employed to optimize efficiency of extrusion of polymeric material it is not always feasible, economically or logistically, to replace an extruder. Problems with feeding in an existing extruder may be attributed, at least in part, by the design of the feed throat and its cooperation with the feed hopper. In some embodiments, the present invention includes an adapter that comprises an altered passageway—the adapter passageway—from the hopper, through the feed throat and into the barrel. The adapter is designed to alter the passageway, promoting movement into the barrel as opposed to being kicked back towards the hopper by directing the pellets to the incoming side of the rotating screw. The adapter can be inserted and removed quickly, minimizing downtime associated with alteration of existing equipment.

When designing an adapter in conjunction with the embodiments of the invention described herein, there are a number of considerations, including the shape, size, and position of the passageway after addition of the adapter, and the means of attachment and composition of the adapter.

The cross-sectional dimensions of the passageway of existing extruder may be altered such that the passageway at its entrance and exit—where it reaches the screw—may be the same or different. The cross sectional area of the passageway of the existing extruder may be altered by the adapter such that it maintains its cross sectional shape throughout the depth of the passageway or may have a sloping geometry where it narrows as it gets closer to the screw. The passageway of the existing extruder may also be altered by the adapter such that the shape is changed and may either maintain the new shape or the new shape may shrink, narrowing throughout the passageway as it gets closer to the barrel. As used when discussing the shape of the passageway, “essentially constant” refers to adapters where the shape of the passageway, or any associated dimensions, are maintained throughout the depth of the passageway and do not vary more than 2%, typically less than 1%.

In an embodiment of the invention, the existing extruder comprises an entrance and end to the passageway having a rectangular shape, and the adapter proportionally reduces each of W, W′, L, and L′, and comprises an adapter passageway having an entrance and end with similar dimensions that remain essentially constant throughout the depth of the adapter passageway.

In an embodiment of the invention, the existing extruder comprises an entrance and end to the passageway having a rectangular shape, and the adapter proportionally reduces each of W, W′, L, and L′, from 2.5 to 50% and comprises an adapter passageway having a cross-sectional area that remains essentially constant throughout the depth of the adapter passageway.

In an embodiment of the invention, the existing extruder comprises an entrance and end to the passageway having a rectangular shape, and the adapter proportionally reduces each of W, W′, L, and L′, from 2.5 to 35% and comprises an adapter passageway having a cross-sectional area that remains essentially constant throughout the depth of the adapter passageway.

In an embodiment of the invention, the existing extruder comprises an entrance and end to the passageway having a rectangular shape, and the adapter proportionally reduces each of W, W′, L, and L′, from 5 to 20% and comprises an adapter passageway having a cross-sectional area that remains essentially constant throughout the depth of the adapter passageway.

In an embodiment of the invention, the existing extruder comprises an entrance and end to the passageway having a rectangular shape, and the adapter proportionally reduces W and L, from 2.5 to 50% and comprises an adapter passageway having a cross-sectional area that decreases throughout its depth such that W is greater than W′ and L is greater than L′.

In an embodiment of the invention, the existing extruder comprises an entrance and end to the passageway having a rectangular shape, and the adapter proportionally reduces W and L, from 2.5 to 35% and comprises an adapter passageway having a cross-sectional area that decreases throughout its depth such that W is greater than W′ and L is greater than L′.

In an embodiment of the invention, the existing extruder comprises an entrance and end to the passageway having a rectangular shape, and the adapter proportionally reduces W and L, from 5 to 20% and comprises an adapter passageway having a cross-sectional area that decreases throughout its depth such that W is greater than W′ and L is greater than L′.

Problems associated with feeding may not necessarily be attributed to the cross-sectional length of the feed throat passageway. Provided that one full flight is under the hopper the length is not normally the issue. Alteration of the width of the passageway may on its own provide the desired improvement in feeding.

In an embodiment of the invention, the existing extruder comprises an entrance and end to the passageway having a rectangular shape, and the adapter reduces W and comprises an adapter passageway having an entrance and end with similar dimensions that remain essentially constant throughout the depth of the adapter passageway.

In an embodiment of the invention, the existing extruder comprises an entrance and end to the passageway having a rectangular shape, and the adapter reduces W from 2.5 to 50% and comprises an adapter passageway having an entrance and end with similar dimensions that remain essentially constant throughout the depth of the adapter passageway.

In an embodiment of the invention, the existing extruder comprises an entrance and end to the passageway having a rectangular shape, and the adapter reduces W from 2.5 to 35% and comprises an adapter passageway having an entrance and end with similar dimensions that remain essentially constant throughout the depth of the adapter passageway.

In an embodiment of the invention, the existing extruder comprises an entrance and end to the passageway having a rectangular shape, and the adapter reduces W from 5 to 20% and comprises an adapter passageway having an entrance and end with similar dimensions that remain essentially constant throughout the depth of the adapter passageway.

In an embodiment of the invention, the existing extruder comprises an entrance and end to the passageway having a rectangular shape, and the adapter reduces W from 2.5 to 50% and comprises an adapter passageway having a cross-sectional area that decreases throughout its depth such that W is greater than W′.

In an embodiment of the invention, the existing extruder comprises an entrance and end to the passageway having a rectangular shape, and the adapter reduces W from 2.5 to 35% and comprises an adapter passageway having a cross-sectional area that decreases throughout its depth such that W is greater than W′.

In an embodiment of the invention, the existing extruder comprises an entrance and end to the passageway having a rectangular shape, and the adapter reduces W from 5 to 20% and comprises an adapter passageway having a cross-sectional area that decreases throughout its depth such that W is greater than W′.

It is also known in the art that feed throat passageways that are “off center” display fewer problems because the passageway is over the incoming side of the rotating screw. By “off center” it is meant that the center of the passageway, relative to the longitudinal axis of the rotating screw, is not directly over the longitudinal axis of the rotating screw but is shifted towards the incoming side. Polymer contacting the incoming side are pulled into the barrel, in contrast to polymer reaching the counter side first where the upward force of the screw can direct the polymer back up towards the hopper.

In an embodiment of the invention, the existing extruder comprises an entrance and end to the passageway having a rectangular shape, and an adapter passageway that is aligned over the incoming side of the rotating screw by shifting the center of the adapter passageway from 0.05 to 0.5D relative to the longitudinal axis of the rotating screw.

In an embodiment of the invention, the existing extruder comprises an entrance and end to the passageway having a rectangular shape, and an adapter passageway that is aligned over the incoming side of the rotating screw by shifting the center of the adapter passageway from 0.05 to 0.35D relative to the longitudinal axis of the rotating screw.

In an embodiment of the invention, the existing extruder comprises an entrance and end to the passageway having a rectangular shape, and an adapter passageway that is aligned over the incoming side of the rotating screw by shifting the center of the adapter passageway from 0.1 to 0.20D relative to the longitudinal axis of the rotating screw.

In an embodiment of the invention, the existing extruder comprises an entrance and end to the passageway having a rectangular shape, and the adapter reduces W from 5 to 50% and comprises an adapter passageway that is aligned over the incoming side of the rotating screw by shifting the center of the adapter passageway from 0.05 to 0.50D relative to the longitudinal axis of the rotating screw and having an entrance and end with similar dimensions that remain essentially constant throughout the depth of the adapter passageway.

In an embodiment of the invention, the existing extruder comprises an entrance and end to the passageway having a rectangular shape, and the adapter reduces W from 2.5 to 35% and comprises an adapter passageway that is aligned over the incoming side of the rotating screw by shifting the center of the adapter passageway from 0.05 to 0.35D relative to the longitudinal axis of the rotating screw and having an entrance and end with similar dimensions that remain essentially constant throughout the depth of the adapter passageway.

In an embodiment of the invention, the existing extruder comprises an entrance and end to the passageway having a rectangular shape, and the adapter reduces W from 5 to 20% and comprises an adapter passageway that is aligned over the incoming side of the rotating screw by shifting the center of the adapter passageway from 0.10 to 0.20D relative to the longitudinal axis of the rotating screw and having an entrance and end with similar dimensions that remain essentially constant throughout the depth of the adapter passageway.

In an embodiment of the invention, the existing extruder comprises an entrance and end to the passageway having a rectangular shape, and the adapter reduces W from 2.5 to 50% and comprises an adapter passageway that is aligned over the incoming side of the rotating screw by shifting the center of the adapter passageway from 0.05 to 0.50D relative to the longitudinal axis of the rotating screw and having a cross-sectional area that decreases throughout its depth such that W is greater than W′.

In an embodiment of the invention, the existing extruder comprises an entrance and end to the passageway having a rectangular shape, and the adapter reduces W from 2.5 to 35% and comprises an adapter passageway that is aligned over the incoming side of the rotating screw by shifting the center of the adapter passageway from 0.05 to 0.35D relative to the longitudinal axis of the rotating screw and having a cross-sectional area that decreases throughout its depth such that W is greater than W′.

In an embodiment of the invention, the existing extruder comprises an entrance and end to the passageway having a rectangular shape, and the adapter reduces W from 5 to 20% and comprises an adapter passageway that is aligned over the incoming side of the rotating screw by shifting the center of the adapter passageway from 0.10 to 0.20D relative to the longitudinal axis of the rotating screw and having a cross-sectional area that decreases throughout its depth such that W is greater than W′.

By defining the dimensions of the cross-sectional area further to distinguish between the length of the entrance and end of the passageway on the incoming and counter sides, it is possible to describe a further embodiment where improved feeding can be seen with the counter side is reduced in length by an amount than any decrease in length on the incoming side. By ensuring the incoming side is longer, there is a tendency to promote the direction of polymer into the incoming side over the counter side allowing for easier entrance into the barrel. For these purposes, the length of the rectangle on the incoming side of the entrance and end of the passageway are L₁ and L₁′, respectively. Further, the length of the rectangle on the counter side of the entrance and end of the passageway are L₂ and L₂′, respectively.

In an embodiment of the invention, the existing extruder comprises an entrance and end to the passageway having a rectangular shape, and the adapter reduces at least one of L₁′, L₂, and L₂′ from 2 to 25%, wherein L₁ is greater than or equal to L₂, L₁′ is greater than or equal to L₂′, and L₁ is greater than or equal to L₁′ and comprises an adapter passageway having a cross-sectional area that decreases throughout its depth.

In an embodiment of the invention, the existing extruder comprises an entrance and end to the passageway having a rectangular shape, and the adapter reduces at least one of L₁′, L₂, and L₂′ from 2 to 20%, wherein L₁ is greater than or equal to L₂, L₁′ is greater than or equal to L₂′, and L₁ is greater than or equal to L₁′ and comprises an adapter passageway having a cross-sectional area that decreases throughout its depth.

In an embodiment of the invention, the existing extruder comprises an entrance and end to the passageway having a rectangular shape, and the adapter reduces at least one of L₁′, L₂, and L₂′ from 2 to 20%, wherein L₁ is greater than or equal to L₂, L₁′ is greater than or equal to L₂′, and L₁ is greater than or equal to L₁′ and comprises an adapter passageway having a cross-sectional area that decreases throughout its depth.

The embodiments listed herein are for demonstration and are not intended to limit the alterations available to the adapter when used in conjunction with the present invention. That is, the adapter may alter one or all of the size, shape, and position relative to the longitudinal axis of the rotating screw. For example, the adapter may change the shape of the entrance to a circle while keeping the exit of the passageway in the shape of a rectangle, or may shift the position of the exit while reducing the width of the rectangle.

In order for the adapter to perform its role, it must be capable of not only altering the passageway but must do so while maintaining its position within the hopper and feed throat. An adapter that moves while polymer is passing through may not be as effective as an adapter that is firmly in place. The adapter may be held in its place by any means that limits or prevents movement. This includes, but is not limited to, a snug close proximity fit and various means of attachment such as a clamp, a clip, or by bolting, screwing, or nailing the adapter in its place. When using a snug close proximity fit care must be taken to ensure that the fit is tight enough that in the event there is kick back from polymer the adapter is not dislodged.

In an embodiment of the invention, the adapter is held in place by a snug close proximity fit between all sides of the adapter in contact with the hopper near the hopper discharge end, and between all sides of the adapter in contact with feed throat.

The replaceable adapter 10 may be constructed with a variety of materials. This includes, but is not limited to, plastic, aluminum, reinforced ceramic, graphene, glass fiber, carbon fiber, and stainless steel. Ideally, the material chosen maintains its shape and is resistant to wear and tear, mostly caused by damage from pellets that are kicked backward from the rotating screw. One embodiment includes a replaceable adapter that is comprised of stainless steel which is more resistant to wear and tear. A person skilled in the art would appreciate that a replaceable adapter 10 may be composed of plastic and still function, but would be more susceptible to wear and tear and require replacement sooner than a similar adapter composed of aluminum or stainless steel.

Design of the replaceable adapter 10 must consider that it performs its function of altering the shape of passageway 8 while maintaining its position relative to the feed hopper 4 and feed throat 2. In one embodiment of the invention the replaceable adapter 10 is comprised of a single piece of molded plastic wherein the shape of the adapter provides for a tight fit within the feed hopper and further includes a passageway that is distinct from the passageway of the extruder prior to insertion of the adapter.

In another embodiment of the invention, the adapter comprises two parts: an upper portion that cooperates with the feed hopper and allows for securing the adapter to the feed hopper by way of a clamp, a clip, or other means of securing where the method of securing involves the passing through part of the barrel, or hopper, or both, a bolt, screw, or nail—see FIG. 2C for a non-limiting example where the adapter is secured in place by a bolt 13 that passes through the hopper, adapter, and then attaches to the barrel; and a lower portion that fits within and alters the passageway. The upper and lower parts may be separate pieces that are connected to each other by any suitable means, including, but not limited to, use of adhesives, welding, or fasteners such as bolts, screws, clips, and nails.

### EXAMPLES

Further details of the invention are illustrated in the following, non-limiting examples.

Assessment of adapter designs is achieved by comparing the pressure fluctuation range, motor load range, and specific output between extrusions of a polymer sample when done with and without the adapter in place.

Efficient extrusion occurs when polymer can flow freely into the extruder barrel with little or no interruption. When this happens the pressure within the extruder fluctuates in a very limited range. When there are problems with feeding the pressure varies as there are gaps along the screw where there is little or no polymer. Also, when there is no polymer the resistance is minimal resulting in a drop in the current required to drive the motor that is rotating the extruder screw. An extrusion where the pressure fluctuation range and motor load ranges are small and the motor load is higher is more efficient than an extrusion where the ranges are broad and the motor load is reduced.

A benefit to more efficient extrusion is the increase in the specific output—measure in lbs/hr/rpm—of extruded polymer. When feeding problems occur, the specific output cannot be improved regardless of increases in feeding or motor load applied to the screw. Increasing the speed of rotation has little or no effect because the polymer is not reaching the screw as efficiently as possible.

Included are two examples of extrusion using different adapter designs and a control extrusion where no adapter is employed.

For each extrusion, NOVA Chemicals polymer FP 120-C was extruded at 45 lbs/hr on a Brampton 9-Layer Blown Film Line. The extruder screw used is 1.5-inches in diameter and uses one single flight to convey material through an extruder barrel. Extruder barrel has an internal diameter of 1.5-inches. While the barrel and screw diameters are referred to as being the same, manufacturers will provide screws just under the indicated diameter referred to so as to provide common industrially accepted clearances. The entrance to the passageway between the hopper and the barrel, without the adapter, is rectangular shaped with rounded corners and has a width of about 3.0 inches and a length of about 2.5 inches. The passageway is off center in it is shifted off the longitudinal axis of the screw by about ¼ inch. The width of the passageway narrows closer to the screw resulting in an exposed surface area of the screw with a rectangular shape with a width of 1.5 inches and length of 2.5 inches. Furthermore, the exposed surface area is in approximate alignment with the longitudinal axis of the screw.

### Plastic Adapter

The first example is a plastic adapter that reduced the width of the entrance to the passageway by about 20%. The reduction of the width included a 10% reduction on each of the counter and incoming sides of the screw, the effect of which was to maintain the offset position of the entrance relative to the longitudinal axis of the screw. The width of the exposed surface area of the screw was also reduced by about 20% (10% on each side of the screw). The adapter is a single piece of molded plastic and is held in place by a close proximity fit, and cannot move down towards the screw due to the narrowing of the feed throat and cannot move upwards due to the position of the hopper.

### Metal Adapter

The second example is an aluminum adapter that reduced the length of the rectangle for both the entrance to the passageway and the exposed surface area of the screw. The length on the counter side was reduced by about 40% and the length on the incoming side was about 20%, changes which affected both the entrance to the passageway and the exposed surface area of the screw. The adapter included two parts, bolted together, including a plate for attachment to the barrel (similar to FIG. 2C) and a lower extension that affected the changes to the shape of the passageway and the exposed surface area of the screw. The adapter is held in place by bolts that pass through the hopper and the plate and are secured to the extruder barrel.

### Results

The extrusion results for the samples, compared with results where no adapter was used, are shown in Table 1. Both samples clearly show that altering the shape of the entrance to the passageway and the exposed surface area of the screw may decrease pressure fluctuations and motor load range while increasing the specific output.

TABLE 1
Extrusion Results

| Criteria | No Adapter | Plastic | Aluminum |
|---|---|---|---|
| Pressure fluctuation range (psi) | 179 | 86 | 84 |
| Motor load range (amps) | 16 (42-58) | 3 (70-73) | 4 (69-73) |
| Specific output (lbs/hr/rpm) | 0.387 | 0.499 | 0.500 |

What is claimed is:

1. A polymer extruder comprising:
i) an extruder barrel having a feed throat and a barrel discharge end;
ii) a feed hopper having a feed opening, that accepts polymer, and a hopper discharge end, wherein said feed hopper cooperates with said extruder barrel in a fashion that allows polymer to pass from said feed hopper through said hopper discharge end to said extruder barrel via a passageway within said feed throat;
iii) at least one extruder screw with a diameter D that is driven by a motor so as to rotate within said extruder barrel in a manner that transports said polymer in the direction from said feed throat to said barrel discharge end and wherein the side of said extruder screw relative to its longitudinal axis that is rotating upwards towards the feed throat is the counter side and the side of said extruder screw relative to its longitudinal axis that is rotating downwards away from the feed throat is the incoming side; and
iv) at least one adapter that cooperates with said hopper discharge end and said feed throat such that said adapter alters at least one parameter selected from:
a. the volume of said passageway;
b. the size of the entrance of said passageway as viewed from said feed hopper;
c. the cross-sectional shape of the entrance of said passageway as viewed from said feed hopper;
d. the size of the exit of said passageway as viewed from said feed hopper;
e. the cross-sectional shape of the exit of said passageway as viewed from said feed hopper; and
f. the position of the exit of said passageway relative to longitudinal axis of said extruder screw.

2. The polymer extruder of claim 1 wherein D is from about 1 cm to about 4 cm.

3. The polymer extruder of claim 2 wherein said adapter is held in place in a manner selected from:
i) a snug close proximity fit;
ii) a clamp;
iii) a clip; and
iv) passing through at least a portion of said adapter and said extruder barrel, and optionally said feed hopper, a means of attachment selected from:
a. a bolt;
b. a screw; and
c. a nail.

4. The polymer extruder of claim 3 wherein:
i) the entrance to said passageway has a rectangular shape with dimensions having a width W and a length L, where W is measured perpendicular to longitudinal axis of said extruder barrel and L is measured parallel to said longitudinal axis of said extruder barrel;
ii) the exit of said passageway comprises:
a. a rectangular shape with dimensions having a width W and a length L′ where W′ is measured perpendicular to said longitudinal axis of said extruder barrel and L′ is measured parallel to said longitudinal axis of said extruder barrel; and
b. a central longitudinal axis that is aligned with the longitudinal axis of said extruder screw.

5. The polymer extruder of claim 4 wherein:
i) W is greater than or equal to W′; and
ii) L is greater than or equal to L′.

6. The polymer extruder of claim 5 wherein said adapter reduces at least one of W, W′, L, and L′ in an amount of from 10 to 50%, provided that L remains greater than or equal to L′, and W remains greater than or equal to W′.

7. The polymer extruder of claim 5 wherein said adapter alters at least one of said entrance to said passageway and said exit of said passageway to a quadrilateral shape by reducing L or L′ on the counter side of said extruder screw in an amount from 5 to 25% without concomitant reduction of L or L′ on the incoming side of said extruder screw.

8. The polymer extruder of claim 7 wherein said adapter alters position of said exit of said passageway such that said central longitudinal axis of said exit of said passageway is moved away from longitudinal axis of said extruder screw toward incoming side of said extruder screw by a distance in an amount from 0.05 D to 0.5 D.

9. The polymer extruder of claim 4 wherein said adapter alters the shape of said entrance to said passageway to a circle with a diameter E₁ from about 0.5 W to about 1.0 W and/or the shape of said exit of said passageway to a circle with a diameter E2 from about 0.5 W to about 1.0 W with the proviso that E₁ is greater than or equal to E₂.

10. A process for extrusion of polymeric material comprising feeding a polymer feedstock to the feed opening of a polymer extruder defined in claim 1.

11. The polymer extruder of claim 1 wherein said adapter is made from a material selected from the group comprising:
i) aluminum;
ii) stainless steel; and
iii) plastic.
